(19) United States
(12) Patent Application Publication
(10) Pub. No.: US 2024/0316814 A1
(43) Pub. Date: Sep. 26, 2024

(54) CUTTING DEVICE AND PRINTER APPARATUS

(71) Applicant: TOSHIBA TEC KABUSHIKI KAISHA, Tokyo (JP)

(72) Inventors: Shuji Yokoyama, Sunto Shizuoka (JP); Toshiya Inomata, Yokohama Kanagawa (JP); Koichi Ando, Mishima Shizuoka (JP)

(21) Appl. No.: 18/408,613

(22) Filed: Jan. 10, 2024

(30) Foreign Application Priority Data
Mar. 20, 2023 (JP) 2023-044542

(51) Int. Cl. B26D 7/01; B41J 3/407; B41J 11/66; B41J 13/03

(52) U.S. Cl. CPC B26D 7/015; B41J 3/4078; B41J 11/66; B41J 13/03

(57) ABSTRACT

According to one embodiment, there is provided a cutting device including a cutting section configured to cut a conveyed long cloth medium into a predetermined length, a placement surface for placing the cloth medium cut by the cutting section, and a paddle section attached to a rotation shaft that is rotatable in a conveyance direction of the cloth medium, configured to come into contact with the placement surface by rotating around the rotation shaft, and configured to scrape out the cloth medium in the conveyance direction.

### CROSS-REFERENCE TO RELATED APPLICATION

This application is based upon and claims the benefit of priority from Japanese Patent Application No. 2023-044542, filed on Mar. 20, 2023, the entire contents of which are incorporated herein by reference.

### FIELD

Embodiments described herein relate generally to a cutting device and a printer apparatus.

### BACKGROUND

Conventionally, a printer apparatus that prints on a long paper medium (hereinafter referred to as a paper label) is known. Such a printer apparatus is provided with a cutting device that includes a cutter mechanism for cutting a medium portion on which printing is completed.

Further, the printer apparatus described above is also used for printing on a medium other than paper. For example, the printer apparatus is sometimes used for printing a care label for quality indication added to clothing and the like. In this case, the printer apparatus issues the care label by printing on a long cloth medium (hereinafter also referred to as cloth label) formed of a material such as polyester and cutting the portion of the medium on which printing is completed using a cutting device.

By the way, the cloth label has a different property from the paper label. Specifically, the cloth label has a property of being weak in stiffness and more easily electrified than the paper label medium. Therefore, for example, there is a possibility that the cloth label is electrified due to friction or the like during cutting, and there is a problem in that JAM is likely to occur after cutting, such as if the electrified cloth label sticks around the cutter.

### DESCRIPTION OF THE DRAWINGS

FIG. 1 is a diagram illustrating an example of a schematic configuration of a printer and a post-processing device according to an embodiment;

FIG. 2 is a vertical sectional right side view illustrating an enlarged view of main parts of a cutting section and a conveyance unit provided in the post-processing device;

FIG. 3 is a diagram for illustrating operations of the cutting section and the conveyance unit;

FIG. 4 is a diagram for illustrating operations of the cutting section and the conveyance unit;

FIG. 5 is a diagram for illustrating operations of the cutting section and the conveyance unit;

FIG. 6 is a diagram for illustrating operations of the cutting section and the conveyance unit; and

FIG. 7 is a diagram for illustrating operations of the cutting section and the conveyance unit.

### DETAILED DESCRIPTION

Embodiments provide a cutting device and a printer apparatus that can efficiently output a cut cloth label.

In general, according to one embodiment, a cutting device includes a cutting section, a placement surface, and a paddle section. The cutting section is configured to cut a conveyed long cloth medium into a predetermined length. The cloth medium cut by the cutting section is placed on the placement surface. The paddle section is attached to a rotation shaft that is rotatable in a conveyance direction of the cloth medium, is configured to come into contact with the placement surface by rotating around the rotation shaft, and is configured to scrape out the cloth medium in the conveyance direction.

Hereinafter, embodiments will be described in detail with reference to the drawings. The cutting device and the printer apparatus of an exemplary embodiment are not limited to the embodiments described below.

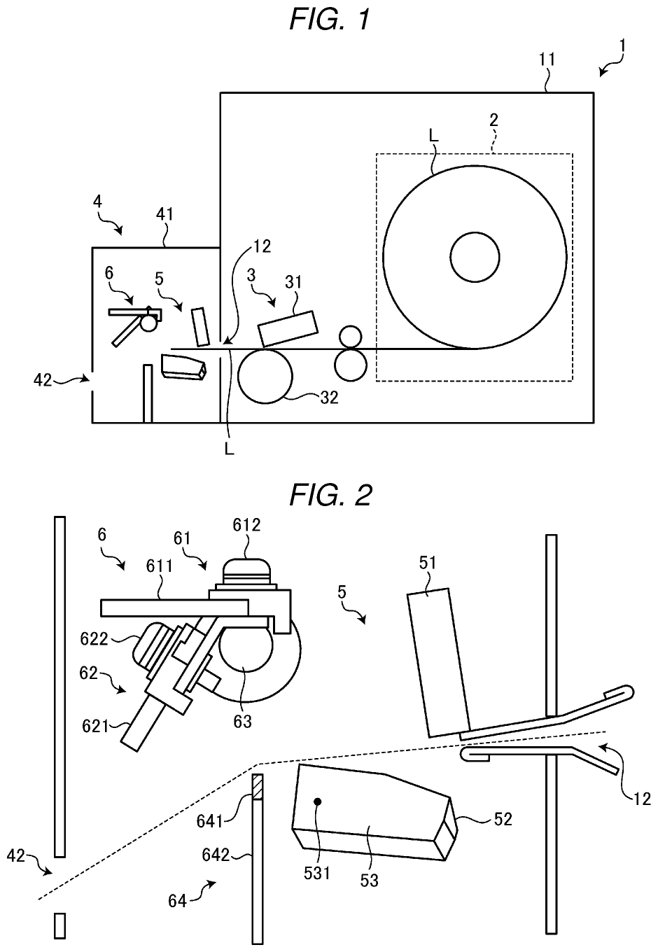

FIG. 1 is a diagram illustrating an example of a schematic configuration of a printer 1 and a post-processing device 4 according to an embodiment. The printer 1 is an example of a printer apparatus in the exemplary embodiment. In FIG. 1, the left side is a front side of the printer 1. Hereinafter, expressions such as top, bottom, left, right, front, back, and front surface in descriptions using drawings are based on the front of the printer 1.

The printer 1 includes a medium holding section 2 and a printing section 3 inside a casing 11. The post-processing device 4 is connected to the front side of the printer 1.

The medium holding section 2 holds a cloth label L wound into a roll shape so that the cloth label L can be freely fed out. Here, the cloth label L is a long cloth medium made of a material such as polyester.

The printing section 3 includes a print head 31 and a platen 32. The cloth label L fed out from the medium holding section 2 is inserted between the print head 31 and the platen 32, and is conveyed toward the post-processing device 4, which will be described later.

The print head 31 is, for example, a thermal head, and prints on the cloth label L fed out from the medium holding section 2. In this case, the print head 31 may perform printing using an ink ribbon (not illustrated) inserted between the print head 31 and the platen 32. The cloth label L printed by the printing section 3 is conveyed to the post-processing device 4 through a communication port 12 provided between the printer 1 and the post-processing device 4. A printing method of the printing section 3 is not particularly limited.

The post-processing device 4 is an example of the cutting device. The post-processing device 4 includes a cutting section 5 and a conveyance unit 6 inside a casing 41. The cutting section 5 cuts the cloth label printed by the printing section 3. The conveyance unit 6 conveys the cloth label L cut by the cutting section 5 and discharges the cloth label L from a discharge port 42 provided on the front side of the casing 41. Here, a path of the cloth label L conveyed from the communication port 12 of the printer 1 toward the discharge port 42 becomes a conveyance path of the cloth label L in the post-processing device 4.

FIG. 2 is a vertical sectional right side view illustrating an enlarged view of main parts of the cutting section 5 and the conveyance unit 6 provided in the post-processing device 4. In FIG. 2, the conveyance path of the cloth label L is illustrated by a broken line.

The cutting section 5 performs an operation for cutting the cloth label L conveyed from the printing section 3. Specifically, the cutting section 5 includes a fixed blade 51, a movable blade 52, and a movable blade drive portion 53.

The fixed blade 51 is provided above the conveyance path at the rear stage of the communication port 12, and has a blade facing the conveyance path at the lower end thereof. FIG. 2 illustrates an example in which a guide member for guiding the conveyance from the printer 1 to the post-processing device 4 is provided on the communication port 12.

The movable blade drive portion 53 is a substantially box-shaped member that is provided below the conveyance path and extends in the conveyance direction. The movable blade drive portion 53 has an axis 531 parallel to a width direction of the printer 1 on the downstream side in the conveyance direction (front side of printer 1), and is supported so as to be rotatable around the axis 531.

Here, an upper surface of the movable blade drive portion 53 becomes a placement surface on which the cut cloth label L is placed. The upper surface of the movable blade drive portion 53 may be a flat surface, or may have a chevron shape or the like in consideration of conveyance of the cloth label L, as illustrated in FIG. 2. However, the upper surface of the movable blade drive portion 53 is preferably a smooth sliding surface in order to realize smooth conveyance. A length of the fixed blade 51 and the movable blade 52 (movable blade drive portion 53) in the width direction of the printer 1 is greater than a length of the cloth label L in the width direction.

The movable blade 52 is fixed to an upper end portion of the movable blade drive portion 53 on the upstream side in the conveyance direction (on the rear side of the printer 1), and has a blade facing the conveyance path. Here, the fixed blade 51 and the movable blade 52 are examples of the cutting section. The movable blade 52 cuts the cloth label L by pinching the cloth label L between the movable blade 52 and the fixed blade 51 by moving from the bottom to the top and from the top to the bottom of the conveyance path as the movable blade drive portion 53 rotates around the axis 531. That is, the length and shape of the rear side of the movable blade drive portion 53 are designed so that the movable blade 52 passes through a position where the movable blade 52 meshes with the fixed blade 51 due to the rotation of the movable blade drive portion 53 around the axis 531.

The conveyance unit 6 is provided downstream of the cutting section 5 in the conveyance direction, and performs an operation for discharging the cloth label L cut by the cutting section 5 from the discharge port 42. Specifically, the conveyance unit 6 includes a first paddle section 61, a second paddle section 62, a paddle rotation shaft 63, and a guide section 64.

The paddle rotation shaft 63 is a rotation shaft provided parallel to the width direction of the printer 1, and is provided, for example, above the conveyance path at the rear stage of the fixed blade 51. The paddle rotation shaft 63 is configured to be rotatable in conjunction with a rotation operation of the movable blade drive portion 53, that is, in conjunction with a cutting operation of the cloth label L, via a link mechanism (not illustrated) or the like. Specifically, the paddle rotation shaft 63 rotates in a clockwise direction in the figure corresponding to the conveyance direction of the cloth label L.

The first paddle section 61 and the second paddle section 62 are examples of the paddle section. The first paddle section 61 and the second paddle section 62 are attached to the paddle rotation shaft 63 and are held so as to be rotatable around the paddle rotation shaft 63.

Here, the first paddle section 61 and the second paddle section 62 have different attachment angles with respect to the paddle rotation shaft 63. Specifically, the attachment angles with respect to the paddle rotation shaft 63 are different so that the first paddle section 61 enters the conveyance path first and then the second paddle section 62 enters the conveyance path as the paddle rotation shaft 63 rotates in the clockwise direction in the figure. Although the difference in attachment angle between the first paddle section 61 and the second paddle section 62 is not particularly important, a configuration that can be adjusted depending on the type of cloth label L, and the like is preferably adopted.

The first paddle section 61 includes a first paddle wing 611 and a first fixing portion 612 for fixing the first paddle wing 611 to the paddle rotation shaft 63. The second paddle section 62 similarly includes a second paddle wing 621 and a second fixing portion 622 for fixing the second paddle wing 621 to the paddle rotation shaft 63. The first fixing portion 612 and the second fixing portion 622 are configured with locking members such as screws, for example.

The first paddle wing 611 and the second paddle wing 621 are formed of an elastic member such as ethylene propylene diene rubber (EPDM). The first paddle wing 611 and the second paddle wing 621 have a length that allows the first and second paddle wings 611 and 621 to come into contact with the upper surface of the movable blade drive portion 53 as the paddle rotation shaft 63 rotates. Here, the length of the paddle wing means, for example, the length from the center of the paddle rotation shaft 63 to the tip of the paddle wing, and is not limited to the length of the paddle wing itself. The lengths of the first paddle wing 611 and the second paddle wing 621 may be the same or may be different. In this embodiment, the length of the second paddle wing 621 is longer than that of the first paddle wing 611.

The guide section 64 is a member for guiding the conveyance of the cloth label L cut by the cutting section 5. Specifically, the guide section 64 is provided at a position where the guide section 64 can come into contact with the cloth label L scraped out from the upper surface of the movable blade drive portion 53 from below, on the conveyance path of the cloth label L. More specifically, the guide section 64 is provided approximately below the paddle rotation shaft 63 in the vertical direction.

The guide section 64 includes a destaticizing brush 641 and a support portion 642. The destaticizing brush 641 is an example of a destaticizing member. The destaticizing brush 641 is provided facing upward and destaticizes a conveyed object (cloth label L) conveyed on the conveyance path. The support portion 642 is a support member that supports the destaticizing brush 641 from below.

In the cutting section 5 and the conveyance unit 6 described above, lengths of the first paddle wing 611, second paddle wing 621, and static elimination brush 641 in the width direction of the printer 1 are not particularly limited, but in order to stabilize the conveyance of the cloth label L, the length is preferably equal to or longer than the length in the width direction of the cloth label L.

The printer 1 and the post-processing device 4 are also provided with a configuration related to drive control of the printer 1 and the post-processing device 4 in addition to the configuration described above. For example, the printer 1 includes various sensors, a drive source for rotating the platen 32, a processor that controls the drive of the drive source and the print head 31, and the like. Further, for example, the post-processing device 4 includes various sensors, a drive source for rotating the movable blade drive portion 53 and the paddle rotation shaft 63, a processor that controls the drive of the drive source, and the like.

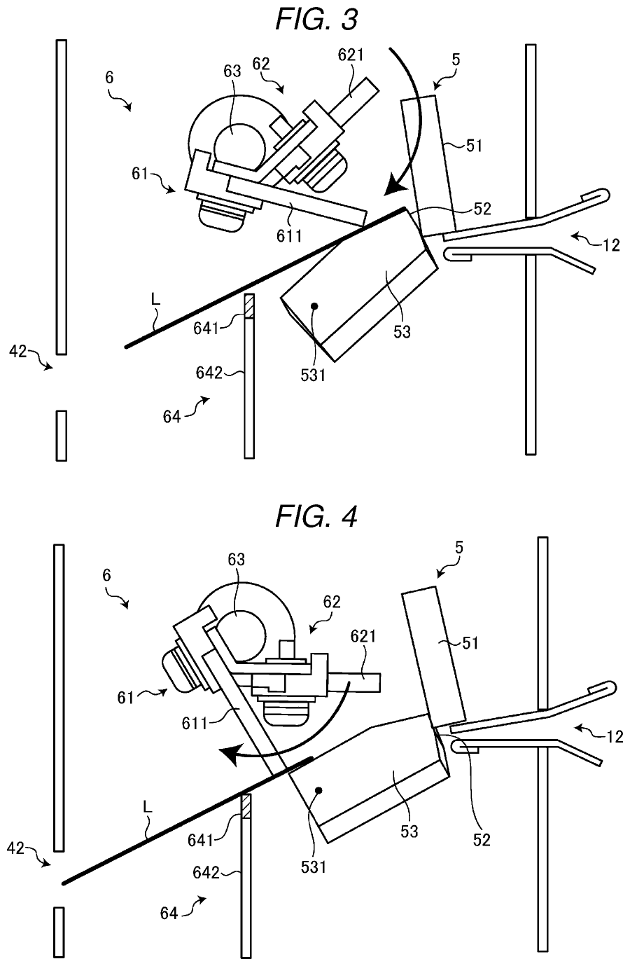

The operations of the cutting section 5 and the conveyance unit 6 will be described below with reference to FIGS. 3 to 7. Here, FIGS. 3 to 7 are diagrams for illustrating the operations of the cutting section 5 and the conveyance unit 6. Similar to FIG. 2, FIGS. 3 to 7 illustrate vertical sectional right side views of the cutting section 5 and the conveyance unit 6.

If printing is performed in the printing section 3, the cloth label L is conveyed to the cutting section 5 through the communication port. In this case, a tip portion of the cloth label L passes between the fixed blade 51 and the movable blade 52, thereby moving to the upper surface of the movable blade drive portion 53.

The movable blade drive portion 53 rotates upward at the timing when the cloth label L is conveyed by a predetermined amount, and cuts the cloth label L by pinching the cloth label L between the fixed blade 51 and the movable blade 52. In this case, the tip portion of the cloth label L is pushed upward as the movable blade drive portion 53 rotates, thereby passing above the guide section 64 and moving toward the discharge port 42.

FIG. 3 illustrates a state immediately after the cloth label L is cut by the cutting section 5. As illustrated in FIG. 3, a portion of the cut cloth label L is placed on the upper surface of the movable blade drive portion 53.

By the way, since the cloth label L used in this embodiment is formed of a material such as polyester, the cloth label L has a property of being weak in stiffness and more easily electrified than a paper label of a paper medium.

Therefore, when handling the cloth label L, there is a possibility that the cloth label L is electrified by sliding (friction) during cutting or conveyance. The electrified cloth label L sticks to surrounding members due to electrostatic force, and thus even if the electrified cloth label L can be cut while maintaining the conveyance speed from the printing section 3, for example, there is a possibility that the electrified cloth label L cannot be normally discharged.

Therefore, in the printer 1 of this embodiment, the mechanism of the conveyance unit 6 described above realizes efficient conveyance of the cloth label. Specifically, as illustrated in FIG. 3, the paddle rotation shaft 63 rotates clockwise in the figure in conjunction with the cloth label cutting operation by the movable blade drive portion 53, that is, an upward rotation operation thereof. The first paddle wing 611 of the first paddle section 61 comes into contact with the upper surface of the movable blade drive portion 53 as the paddle rotation shaft 63 rotates, and moves in the conveyance direction while maintaining the contact state, thereby starting scraping out the cloth label placed on the upper surface of the movable blade drive portion 53 in the conveyance direction.

Thus, for example, even if the cloth label L is stuck to the upper surface of the movable blade drive portion 53, the cloth label L can be moved in the conveyance direction by a scraping-out operation by the first paddle section 61 in the conveyance direction.

As illustrated in FIG. 3, the guide section 64 guides the movement of the cloth label L on the conveyance path, and also destaticizes the cloth label L by making the destaticizing brush 641 provided at the tip thereof come into contact with the cloth label L. With this, the guide section 64 can efficiently guide the conveyance of the cloth label L on the conveyance path.

If the movable blade drive portion 53 finishes cutting the cloth label L, the movable blade drive portion 53 starts rotating downward in order to return to an initial position thereof (for example, the state illustrated in FIG. 2).

Meanwhile, the paddle rotation shaft 63 continues to rotate clockwise. Therefore, while the first paddle wing 611 is in contact with the upper surface of the movable blade drive portion 53, scraping out of the cloth label L in the conveyance direction is continued.

FIG. 4 is a diagram illustrating a state immediately after the first paddle wing 611 is detached from the upper surface of the movable blade drive portion 53. Here, for example, depending on electrostatic force generated on the cloth label L, there is a possibility that the rear end portion of the cloth label L sticks to the upper surface of the movable blade drive portion 53 and remains on the upper surface of the movable blade drive portion 53. Therefore, in this embodiment, the rear end portion of the cloth label L remaining on the upper surface of the movable blade drive portion 53 is scraped out by the second paddle section 62 following the first paddle section 61.

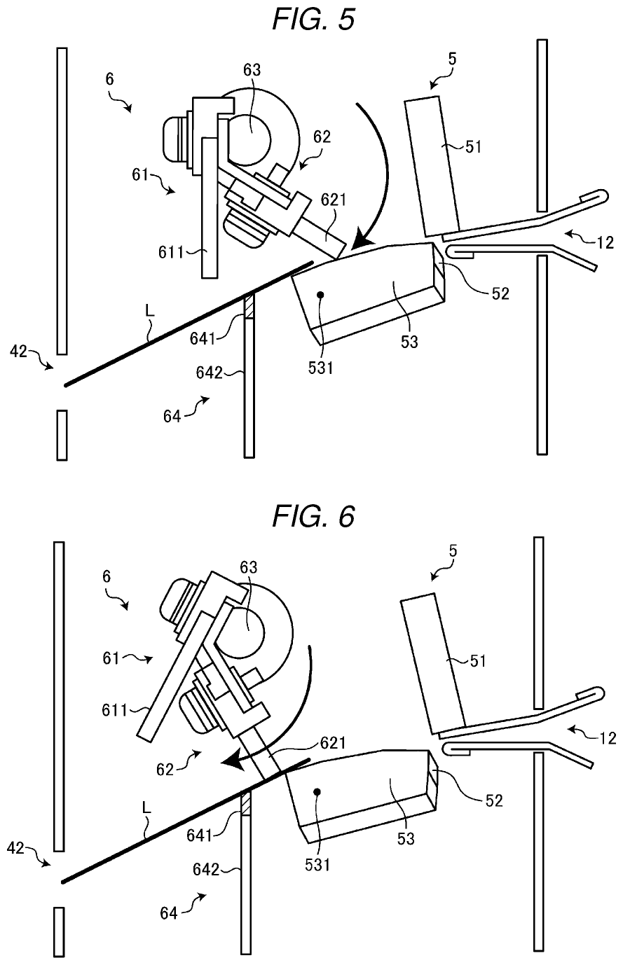

Specifically, as illustrated in FIG. 5, as the paddle rotation shaft 63 rotates clockwise, the second paddle wing 621 of the second paddle section 62 that comes into contact with the upper surface of the movable blade drive portion 53 moves in the conveyance direction along the upper surface. With this, the second paddle section 62 starts scraping out the cloth label L remaining on the upper surface of the movable blade drive portion 53 from the rear end side thereof in the conveyance direction. Then, while the first paddle wing 611 is in contact with the upper surface of the movable blade drive portion 53, the scraping out of the cloth label L in the conveyance direction is continued.

FIG. 6 is a diagram illustrating a state immediately after the second paddle wing 621 is detached from the upper surface of the movable blade drive portion 53. In this way, the conveyance unit 6 can more reliably convey the cloth label L in the conveyance direction by performing the scraping-out operation in the conveyance direction over two stages of the first paddle section 61 and second paddle section 62.

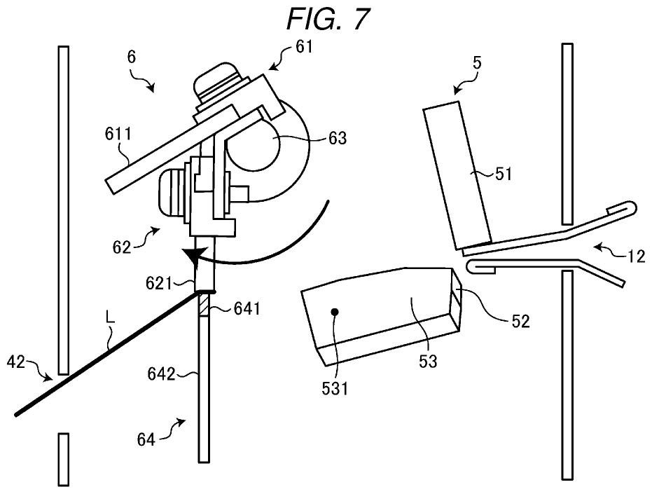

Further, as described above, in this embodiment, the length of the second paddle wing 621 is longer than the first paddle wing 611. Therefore, during the scraping-out operation by the second paddle section 62, as illustrated in FIG. 7, a downward pressing force against the cloth label L is greater than that by the first paddle section 61 at the position of the destaticizing brush 641. With this, in the conveyance unit 6, the rear end portion of the cloth label L, which is particularly prone to sticking due to electrification, can be more reliably destaticized.

Since the destaticizing brush 641 is provided at a height where the destaticizing brush 641 contacts the tip of the second paddle wing 621, if the cloth label L is pinched between the second paddle wing 621 and the destaticizing brush 641, a force in the conveyance direction by the second paddle blade 621 can be applied to the cloth label L. With this, the cloth label L can be discharged more reliably.

After finishing the conveyance of the cloth label L, the paddle rotation shaft 63 continues to rotate until the first paddle section 61 and the second paddle section 62 reach a predetermined standby position (for example, the state in FIG. 2) The cutting section 5 and the conveyance unit 6 perform the operation described above every time the cloth label L is conveyed from the printer 1, under the control of a processor (not illustrated) of the post-processing device 4, thereby discharging the cloth label L on which printing is completed from the discharge port 42.

As described above, the post-processing device 4 of this embodiment cuts the cloth label L conveyed from the printing section 3 into a predetermined length by the cutting section 5, and holds the cut cloth label L on the upper surface of the movable blade drive portion 53. The post-processing device 4 scrapes out the cloth label L placed on the upper surface of the movable blade drive portion 53 in the conveyance direction by the first paddle section 61 attached to the paddle rotation shaft 63, by rotating the paddle rotation shaft 63 in the conveyance direction of the cloth label L in conjunction with the cutting operation of the cutting section 5.

With this, in the post-processing device 4, even if the cut cloth label L is electrified, for example, the cut cloth label L can be urged in the conveyance direction by scraping out the first paddle section 61, and thus the cloth label L can be efficiently output (discharged).

Further, in the post-processing device 4, the second paddle section 62, which is attached to the paddle rotation shaft 63 at an attachment angle different from the first paddle section 61, can scrape out the cloth label L placed on the upper surface of the movable blade drive portion 53 in the conveyance direction at a timing different from that of the first paddle section 61.

With this, in the post-processing device 4, even if the rear end portion of the cloth label L remains on the upper surface of the movable blade drive portion 53 after scraping-out by the first paddle section 61, for example, the cloth label L can be urged in the conveyance direction by scraping-out by the second paddle section 62, and thus the cloth label L can be outputted (discharged) more reliably.

In the post-processing device 4, using the destaticizing brush 641, which is provided at a position where the destaticizing brush 641 can come into contact with the cloth label L scraped out from the upper surface of the movable blade drive portion 53 from below, on the conveyance path at the rear stage of the movable blade drive portion 53, the cloth label L is destaticized. With this, in the post-processing device 4, for example, static electricity generated due to sliding on the upper surface of the movable blade drive unit 53, and the like can be destaticized, and a situation such as sticking during conveyance can be prevented, and thus the cloth label L can be outputted (discharged) efficiently.

In the post-processing device 4, the destaticizing brush 641 is provided approximately below the paddle rotation shaft 63 in the vertical direction, for example, and the destaticizing brush 641 is set at a height where the destaticizing brush 641 can come into contact with the first paddle section 61 and the second paddle section 62. With this, if the first paddle section 61 and the second paddle section 62 perform the scraping-out operation, a state in which the cloth label L and the static elimination brush 641 are in contact with each other can be realized, and thus the cloth label L can be destaticized more reliably.

Further, the embodiment described above can be appropriately modified to be embodied by changing some of the configurations or functions of the printer 1 and the post-processing device 4. Therefore, some modifications of the embodiment described above will be described below as other embodiments. In the following, points that are different from the embodiments described above will be mainly described, and detailed descriptions of points that are common to those already described will be omitted. Further, the modifications described below may be embodied individually or in appropriate combinations.

### Modification 1

In the embodiment described above, the printer 1 and the post-processing device 4 are separately formed, but are not limited thereto, and the printer 1 and the post-processing device 4 may be integrally formed. In this case, a configuration in which the cloth label L on which printing is completed can be discharged from the discharge port provided in the casing 11 by providing the cutting section 5 and the conveyance unit 6 within the casing 11 of the printer 1 may be adopted.

### Modification 2

In the embodiment described above, a configuration in which, for example, the movable blade drive portion 53 is formed of a conductive member such as metal and the movable blade drive portion 53 is connected to a frame such as the casing 41 by GND may be adopted. With this, a potential difference due to electrification of the cloth label L can be prevented, and thus the cloth label L can be conveyed more efficiently.

### Modification 3

In the embodiment described above, a configuration using the first paddle section 61 and the second paddle section 62 is described, but is not limited thereto, and a configuration using only the first paddle section 61 (or second paddle section 62) may be adopted. If the cloth label L can be conveyed only by the scraping-out operation by a single paddle section by adopting the characteristics of the cloth label L and the configuration of modification 2, and the like, a configuration using a single paddle section may also be adopted.

Further, the number of paddle sections is not limited to two, and a configuration in which three or more paddle sections are provided on the paddle rotation shaft 63 depending on the characteristics of the cloth label L used, and the like may be adopted. The attachment angles of the paddle sections with respect to the paddle rotation shaft 63 are set to be different from each other.

### Modification 4

In the embodiment described above, an example in which the movable blade 52 and the placement surface of the cloth label L are integrally configured by attaching the movable blade 52 to the movable blade drive portion 53 is described, but is not limited to the configuration.

A configuration in which, for example, the movable blade 52 is configured to be movable in the vertical direction and a placement surface (placement stand) for placing the cut cloth label L is provided on a rear stage of the movable blade 52 may be adopted. If this configuration is adopted, the first paddle section 61 and the second paddle section 62 of the conveyance unit 6 can achieve the same effect as the embodiment described above by performing an operation of sequentially scraping out the cloth labels L placed on the placement surface.

### Modification 5

In the embodiment described above, a configuration in which the guide section 64 is provided so as to guide the conveyance of the cloth label L is described, but is not limited to the configuration.

For example, depending on the position of the discharge port 42, an output position of the cut cloth label L, and the like, there is a possibility that the guide section 64 is not required. In such a case, a configuration in which the guide section 64 is not provided may be adopted.

In the embodiment described above, the configuration in which the destaticizing member (destaticizing brush 641) is provided at the tip of the guide section 64 is adopted, but is not limited to the configuration.

A configuration in which, for example, if the cloth label L can be discharged without being destaticized, the destaticizing member is removed and the guide section 64 of which the support portion 642 is extended to the height of the destaticizing brush 641 is provided so as to guide the conveyance of the cloth label L, may be adopted.

### Modification 6

In the embodiment described above, the configuration of the cutting section 5 is a swing cutter type of cutting section in which the movable blade 52 moves (swings) up and down with respect to the fixed blade 51, but is not limited thereto. For example, the cutting section 5 may be of another type of cutting section, such as a rotary cutter type of cutting section. However, regardless of which type of the cutting section is used, the cutting section 5 is provided with a placement surface on which the cut cloth label L is placed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A cutting device, comprising:
a cutting component configured to cut a conveyed long cloth medium into a predetermined length;
a placement surface for placing the conveyed long cloth medium cut by the cutting component; and
a paddle component attached to a rotation shaft configured to rotate in a conveyance direction of the conveyed long cloth medium, configured to contact with the placement surface by rotating around the rotation shaft, and configured to scrape out the conveyed long cloth medium in the conveyance direction.

2. The cutting device according to claim 1, wherein
a plurality of the paddle components are attached at different attachment angles to the rotation shaft, configured to contact with the placement surface at different timings by rotating around the rotation shaft.

3. The cutting device according to claim 1, further comprising:
a destaticizing member provided at a position at which the destaticizing member is configured to contact with the conveyed long cloth medium scraped out from the placement surface from below in the conveyance path of the conveyed long cloth medium, and configured to destaticize the cloth medium in contact with the conveyed long cloth medium.

4. The cutting device according to claim 3, wherein
the destaticizing member is provided approximately vertically below the rotation shaft in a vertical direction and at a height where the destaticizing member comes into contact with a tip of the paddle component rotating around the rotation shaft.

5. The cutting device according to claim 1, wherein
the cutting component comprises a fixed blade provided above a conveyance path, a movable blade, and a movable blade drive portion having a substantially box-shaped member provided below the conveyance path and extending in the conveyance direction.

6. The cutting device according to claim 5, wherein
the movable blade drive portion has an axis parallel to a width direction of a printer on a downstream side in the conveyance direction.

7. The cutting device according to claim 5, wherein
an upper surface of the movable blade drive portion has a smooth sliding surface and a length of the fixed blade and the movable blade in a width direction of a printer is greater than a length of a width direction the conveyed long cloth medium.

8. A printer apparatus, comprising:
a printing component configured to print on a long cloth medium;
a cutting component configured to cut the conveyed long cloth medium conveyed from the printing component into a predetermined length;
a placement surface for placing the conveyed long cloth medium cut by the cutting component; and
a paddle component attached to a rotation shaft configured to rotate in a conveyance direction of the conveyed long cloth medium, configured to contact with the placement surface by rotating around the rotation shaft, and configured to scrape out the conveyed long cloth medium in the conveyance direction.

9. The printer apparatus according to claim 8, wherein
a plurality of the paddle components are attached at different attachment angles to the rotation shaft, configured to contact with the placement surface at different timings by rotating around the rotation shaft.

10. The printer apparatus according to claim 8, further comprising:
a destaticizing member provided at a position at which the destaticizing member is configured to contact with the conveyed long cloth medium scraped out from the placement surface from below in the conveyance path of the conveyed long cloth medium, and configured to destaticize the cloth medium in contact with the conveyed long cloth medium.

11. The printer apparatus according to claim 10, wherein
the destaticizing member is provided approximately vertically below the rotation shaft in a vertical direction and at a height where the destaticizing member comes into contact with a tip of the paddle component rotating around the rotation shaft.

12. The printer apparatus according to claim 8, wherein
the cutting component comprises a fixed blade provided above a conveyance path, a movable blade, and a movable blade drive portion having a substantially box-shaped member provided below the conveyance path and extending in the conveyance direction.

13. The printer apparatus according to claim 12, wherein
the movable blade drive portion has an axis parallel to a width direction of the printer apparatus on a downstream side in the conveyance direction.

14. The printer apparatus according to claim 12, wherein
an upper surface of the movable blade drive portion has a smooth sliding surface and a length of the fixed blade and the movable blade in a width direction of the printer apparatus is greater than a length of a width direction the conveyed long cloth medium.

15. A cutting method for a printer apparatus, comprising:
a cutting component configured to cutting a conveyed long cloth medium into a predetermined length;
placing the conveyed long cloth medium cut by the cutting component on a placement surface;
rotating a paddle component attached to a rotation shaft in a conveyance direction of the conveyed long cloth medium;
contacting the paddle component with the placement surface by rotating around the rotation shaft; and
scraping out the conveyed long cloth medium in the conveyance direction.

16. The cutting method according to claim 15, wherein
a plurality of the paddle components are attached at different attachment angles to the rotation shaft, further comprising:
contacting the plurality of the paddle components with the placement surface at different timings by rotating around the rotation shaft.

17. The cutting method according to claim 15, further comprising:
contacting a destaticizing member with the conveyed long cloth medium scraped out from the placement surface from below in the conveyance path of the conveyed long cloth medium; and
destaticizing the cloth medium in contact with the conveyed long cloth medium.

18. The cutting method according to claim 17, wherein
the destaticizing member is provided approximately vertically below the rotation shaft in a vertical direction and at a height where the destaticizing member comes into contact with a tip of the paddle component rotating around the rotation shaft.

19. The cutting method according to claim 15, wherein
the cutting component comprises a fixed blade provided above a conveyance path, a movable blade, and a movable blade drive portion having a substantially box-shaped member provided below the conveyance path and extending in the conveyance direction, the movable blade drive portion has an axis parallel to a width direction of a printer on a downstream side in the conveyance direction.

20. The cutting method according to claim 15, wherein
the cutting component comprises a fixed blade provided above a conveyance path, a movable blade, and a movable blade drive portion having a substantially box-shaped member provided below the conveyance path and extending in the conveyance direction, and
an upper surface of the movable blade drive portion has a smooth sliding surface and a length of the fixed blade and the movable blade in a width direction of a printer is greater than a length of a width direction the conveyed long cloth medium.
